(19) United States
(12) Patent Application Publication
(10) Pub. No.: US 2026/0301466 A1
(43) Pub. Date: Oct. 1, 2026

(54) DEEP-LEARNING BASED HUMAN ACTIVITY RECOGNITION SYSTEM AND METHOD THEREOF

(71) Applicants: Ashish Ghosh, Kolkata (IN); Susmita Ghosh, Kolkata (IN)

(72) Inventors: Ashish Ghosh, Kolkata (IN); Susmita Ghosh, Kolkata (IN); Abhiroop Chatterjee, Kolkata (IN)

(21) Appl. No.: 19/369,727

(22) Filed: Oct. 27, 2025

(30) Foreign Application Priority Data
Mar. 26, 2025 (IN) 202531028287

(51) Int. Cl. G06V 40/20; G06V 10/82

(52) U.S. Cl. CPC G06V 40/20; G06V 10/82

(57) ABSTRACT

The present invention discloses a method of multifaceted deep learning system (101) comprising Enhanced Human Activity Recognition using CNN and Bi-LSTM. The method according to the present invention comprises various stages: Stage I: Data Preprocessing; Stage II: Convolutional Layers (Spatial Feature Extraction); Stage III: LSTM Module (120) (Temporal Modeling); Stage IV: Skip Connections. During Data proessing stage, Video data from the datasets is collected and Videos are resized to a consistent resolution, to ensure uniformity. Temporal segmentation is performed to divide videos into sequences of a fixed length to create input samples. During Convolutional Layers stage, Convolutional layers are applied to the video frames to extract spatial features. During Temporal Modeling stage, Bi-LSTM module (120) is used for modeling temporal dependencies in the video sequences. During Skip Connections stage, Skip connections are added between plurality of convolutional modules to improve gradient flow and training stability.

### FIELD OF THE INVENTION

The present invention relates to the field of developing advanced models capable of recognizing and distinguishing intricate human activities from video data. Particularly, the present invention relates to human activity recognition employing a deep spatiotemporal architecture designed to process video sequences from the dataset. More particularly, the present invention comprises a methodology which provides for building Conv3D layers for spatial and temporal feature extraction, coupled with Bidirectional LSTM module for sequential modeling, to achieve robust and accurate recognition of diverse human activities in real-world video scenarios.

### BACKGROUND OF THE INVENTION

An artificial intelligence technique called a neural network is trained to process information in a manner similar to train the human brain. Deep learning is a kind of machine learning technique which uses networked nodes or neurons arranged in a layered pattern to mimic the organization of the human brain.

Convolutional neural networks, or CNNs for short, are neural networks with several layers which categorizes data. The convolutional networks consist of several hidden convolutional layers sandwiched between an input layer and an output layer. The layers produce feature maps that identify regions of an image that are further subdivided until they produce useful results. The networks are particularly useful for applications involving image identification because the layers are combined or connected in their entirety.

Compared to humans or more basic analytical models, neural networks are more efficient and operate continuously. In order to predict future results based on how closely the models resemble previous inputs, neural networks are also trained to learn from past outputs. While neural networks' intricacy is one of their advantages, that also mean to create a particular algorithm for a certain task that take months, if not longer. Furthermore, the neural networks are challenging to identify any mistakes or flaws in the procedure, particularly if the outcomes are theoretical ranges or estimates.

Human activity recognition (HAR) is a useful tool in the healthcare sector for tracking patients' everyday activities who have long-term illnesses like Parkinson's disease. Human activity recognition (HAR) assist medical practitioners in recognizing alterations in behavior or mobility and modifying treatment regimens accordingly. HAR is applied to sports to analyze athletes' performance and technique, pinpoint problem areas, and enhance training regimens. HAR is used in smart homes to automate equipment and appliances based on human activity. For instance, lights are turned on when someone enters a room. HAR is applied to robotics to enhance robot skills, enabling them to engage with humans more successfully and comprehend human behavior.

In the context of security, HAR is used to identify questionable behavior or incursions in delicate locations like banks, military bases, and airports. All things considered, HAR is a fast expanding subject of research and development with a wide range of applications in diverse disciplines and businesses.

Convolutional neural networks (CNNs) have become integral part of the human activities recognition system. CNNs are made up of several convolutional layers, pooling layers, and fully connected layers, which together provide valuable deep features for a variety of classification and identification tasks. A number of steps are also made to enhance the methods for recognizing human behaviors. The need for modules to be interpretable and explicable is a significant barrier to deep learning.

Along with that, the deep convolutional neural network includes one common challenge that vanishes or explodes gradients during training. The issue arises when gradients become extremely small or large as the gradients propagate backward through the network layers during the process of error back-propagation. When gradients vanish, the network fails to learn effectively, while exploding gradients lead to instability and erratic behavior during training. Therefore, there is requirement to introduce skip connections in between the deep convolutional network.

### Challenges/Gaps in Prior Art:

The prior art in human activity recognition often struggled to effectively capture both spatial and temporal cues from video data. Many existing models either focused predominantly on spatial features or temporal dynamics, limiting their ability to recognize complex activities that evolve over time. Additionally, addressing variations in activity duration and achieving robustness across diverse scenarios remained challenging.

Therefore, in view of above mentioned problems, there is a requirement to introduce a holistic approach that seamlessly combines spatial and temporal information within a single deep learning architecture comprising of CNN and modeling temporal dependencies in the video sequences for enhanced human activities recognition adapting to variations in duration, and achieving superior accuracy in real-world scenarios.

### Objective of the Invention

The primary objective of the present invention is to provide a methodology which focuses on improved human activity recognition.

Another objective of the present invention is to provide a deep neural network architecture optimized for enhanced human activity recognition tasks.

Yet another objective of the present invention is to provide a methodology which provides intricate interplay between spatial and temporal cues to achieve robust and accurate recognition of diverse human activities in real-world video scenarios.

Still another objective of the present invention is to provide accuracy of more than 92% on benchmark datasets by incorporating a predefined dataset.

### SUMMARY OF THE INVENTION

Accordingly, the present invention provides a deep-learning based human activity recognition system (101) and method thereof comprising Enhanced Human Activity Recognition using CNN and Bi-LSTM. The method according to the present invention comprises a data processing unit comprising collection of video data from datasets, resizing the videos to a consistent resolution, extracting spatial features using a plurality of convolutional modules to extract spatial features from individual frames of the input video to further detect patterns and spatial information within each frame, a Temporal Modeling stage comprises of Long Short-Term Memory (LSTM) module (120) for modeling temporal dependencies within the video sequence enabling the model to understand the sequentially evolution of the human activities. Skip connections are added between the plurality of convolutional modules to improve gradient flow and training stability. The present invention also provides a deep spatiotemporal architecture comprising a deep neural network architecture optimized for human activities recognition which further captures spatial and temporal cues within video sequences, enhances gradient flow for effective training, dynamically allocates attention to relevant time steps, thereby employing efficient training strategies. The synergy enables the module to recognize a wide range of human activities with improved accuracy, robustness, and efficiency.

### BRIEF DESCRIPTION OF DRAWINGS

The present invention will be better understood after reading the following detailed description of the presently preferred aspects with reference to the appended drawings:

FIG. 1 illustrates a flowchart and architecture of the deep-learning based human activity recognition system and method thereof.

FIG. 2 illustrates Frames shown for a sample video (Archery) extracted from a single video sample in the context of the Archery action category used to provide an overview of Archery action within the UCF 101 dataset or a similar dataset.

FIG. 3 illustrates the end-to-end structure of the Deep Neural Network module to provide a visual representation of the entire architecture and structure of a deep neural network (DNN) module for human activity recognition system and method thereof.

Other objects and advantages of the present invention will become apparent from the following description taken in connection with the accompanying drawings, wherein, by way of illustration and example, the aspects of the present invention are disclosed.

### DETAILED DESCRIPTION OF THE INVENTION

The following description describes various features and functions of the disclosed system and apparatus. The illustrative aspects described herein are not meant to be limiting. It may be readily understood that certain aspects of the disclosed system and apparatus can be arranged and combined in a wide variety of different configurations, all of which are contemplated herein.

The following description of preferred embodiments of the invention is not intended to limit the invention to these preferred embodiments, but rather to enable any person skilled in the art to make and use this invention.

These and other features and advantages of the present invention may be incorporated into certain embodiments of the invention and will become more fully apparent from the following description as set forth hereinafter.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

### Methodology: Detailed Outline

Accordingly, the present invention comprises a methodology comprising a deep neural network architecture which provides for Enhanced Human Activity Recognition. More particularly, the present invention comprises a deep neural architecture further comprises of building Conv3D layers for spatial and temporal feature extraction, coupled with Bidirectional LSTM module (120) for sequential modeling, to achieve robust and accurate recognition of diverse human activities in real-world video scenarios.

In an embodiment, the present invention provides a deep learning based human activity recognition system (101) comprising:

Graphics processing unit is well-suited for deep-learning tasks in order to accelerate neural network training. The graphics processing unit is preferably a V100 GPU developed by NVIDIA belongs to the Volta architecture.

Central processing unit is responsible for general-purpose computing tasks. The central processing unit is involved in data preprocessing unit, managing the overall training process, and handling tasks that are not well-suited for parallel processing on GPUs.

Memory Unit is essential for storing and quickly accessing data during system training. Sufficient memory is crucial, especially when dealing with large datasets and complex systems. The amount of available memory depends on the type of virtual machine provided in the range of 80 To 90 GB.

Storage Module is necessary for storing datasets, system checkpoints, and other files related to the training process. The storage module is preferably Google Colab to provide cloud storage.

Internet connectivity is needed for accessing and downloading datasets, libraries, and other resources during the development and training process. Internet connectivity is especially relevant for cloud-based platforms like Google Colab.

Server is utilized for deploying the graphics processing unit, the central processing unit, the memory and the storage module in order to serve the trained system (101).

Network is necessary for communication between the deployed system (101) and the application or service using the system (101).

In another embodiment, the neural network architecture is developed for processing spatiotemporal data, such as video sequences, and consists of several interconnected layers to influence the gradient flow and enhance efficient and stable training. The input data is represented as a 4-dimensional tensor with a batch size of 16 samples, each having a spatial resolution of 112×112 pixels and three color channels (RGB). The network starts with a series of a plurality of convolutional modules. The first block is referred to as the “INC” block in the architecture which consists of three Conv3D blocks operating at multiple scales, each with convolutional kernels of sizes 3×3, 5×5, and 7×7 which allows the network to capture features at different levels of granularity within the input volume. After each Conv3D block, a MaxPool3D operation is applied to reduce the spatial dimensions of the feature maps, helping to abstract and extract prominent features. Following the MaxPool3D operation, Batch Normalization is applied to stabilize and normalize the activations within each mini-batch, aiding in faster convergence during training and improving the generalization of the model. Finally, the outputs of all three Conv3D branches are concatenated along the channel dimension, creating a richer representation of the input volume that captures features at multiple scales. The concatenated feature map serves as the input to the subsequent convolutional blocks in our neural network architecture. After the INC block our network consists of four convolutional modules. The first convolutional layer (103) includes a Conv3D layer followed by Batch Normalization and MaxPooling3D, which reduces the spatial dimensions. The batch normalization normalizes the inputs to another layer, reducing internal covariate shift in order to help in stabilizing and speeding up the training process by ensuring that each layer receives inputs with a consistent distribution. The second convolutional layer (105) similarly performs 3D convolutions: (CONV3D), Batch normalization, and spatial downsampling (Maxpool3D). The third convolutional layer (107) contains a pair of CONV3D-Batch normalization followed by a Maxpool3D. A skip connection (as shown in Figure) is also present here. The fourth convolutional layer (109) is also incorporating skip connection along with a CONV3D-Batch normalization layer. The output of the fourth block is passed through a Time distributed (TDL) flatten layer for further preprocessing into the temporal block resulting in a shape of (2, 12544). Following the convolutional layers, the network introduces Bi-LSTM (bidirectional long-short term memory) module (120) that works in bidirectional mode and captures long-range dependencies in sequential data which aids in maintaining a smooth gradient flow over extended sequences. The Bidirectional LSTM module (120) with 512 (2×256, because of “bi” directional) units processes the flattened sequence. Additional layers include a Dense layer with 1 neuron, and a Softmax Activation layer producing attention scores which represents attention scores. The architecture further includes a Multiply layer (113) performing element-wise multiplication, resulting in a shape of (1, 512). A Summation (Reduction) layer (115) aggregates information along the time dimension, yielding a final output shape of (512). The ultimate Output layer is a Dense layer with Softmax activation, generating attention scores based on the spatiotemporal features learned by the preceding layers. The comprehensive architecture effectively integrates spatial and temporal processing, enabling the system (101) to capture intricate patterns in spatiotemporal data for accurate classification.

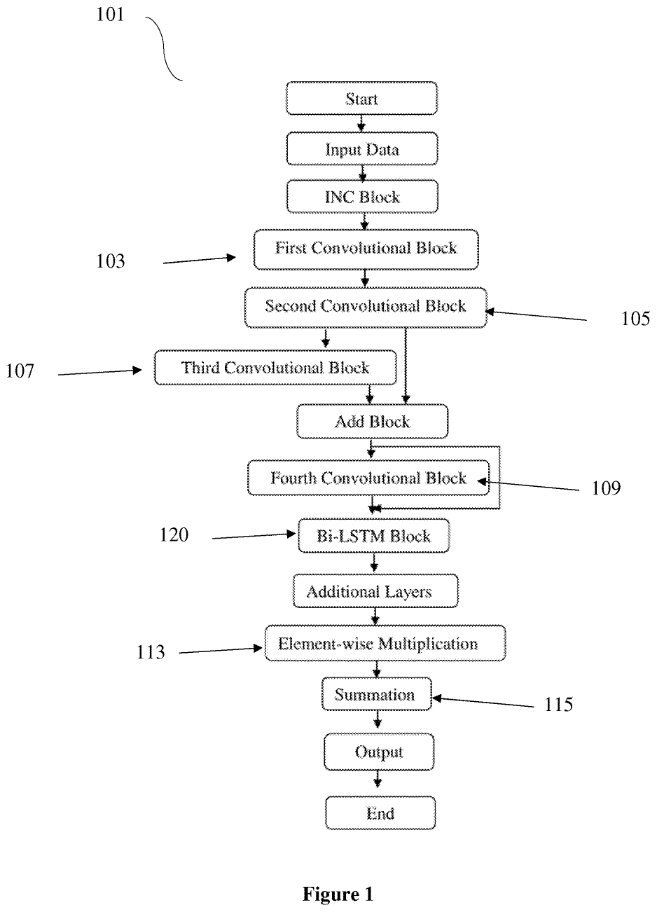

The method according to the present invention comprises various stages as shown in FIG. 1, including but not limited to:

### Stage 1—Data Preprocessing Unit

In the data processing unit, video data from the UCF101 dataset or a similar source is collected and Videos are resized to a consistent resolution, e.g., 112×112 pixels, to ensure uniformity. Then Temporal segmentation is performed to divide videos into sequences of a fixed length (e.g., 16 frames) to create input samples. The dataset consists of 101 action classes, covering a diverse range of activities such as playing musical instruments, sports, and everyday activities. Each action class contains a varying number of video clips demonstrating the corresponding action. These clips are extracted from YouTube videos. UCF101 is considered a large-scale dataset with a significant number of video samples which provides a diverse and challenging set of examples for training and evaluating action recognition system (101). The dataset captures challenging factors such as variations in camera viewpoints, lighting conditions, background clutter, and appearance changes among different instances of the same action. Actions in UCF101 often involve complex temporal dynamics, making it suitable for evaluating system (101) that captures and understands temporal dependencies in video sequences. The dataset is commonly divided into three splits: training, validation, and testing. The dataset facilitates the standard evaluation of system (101) on a hold-out test set. Videos in UCF101 are provided in a standard video format, and the dataset includes annotation files specifying the class labels for each video clip.

### Stage 2—Deep Spatiotemporal Architecture

During the deep spatiotemporal architecture stage, a deep spatiotemporal architecture is meticulously crafted to tackle the challenges of human activity recognition in video data. The present architecture is a designed neural network that seamlessly integrates spatial and temporal information, allowing the system (101) to gain a comprehensive understanding of human activities. Spatial information is primarily captured through the plurality of convolutional modules in the first part of the system (101), specifically through 3D convolutional layers. The layers are developed to learn spatial features from each frame of the input video sequence. The convolutional operations perform spatial filtering, extracting relevant patterns and representations. The layers perform temporal pooling (reducing the temporal dimension by considering the maximum value over certain temporal windows through Maxpooling) and Batch Normalization which helps in capturing key temporal features and reducing the overall sequence length.

### Stage 3—Conv3D Layers for Spatiotemporal Feature Extraction

The stage leverages Convolutional 3D (Conv3D) layers for spatiotemporal feature extraction. The layers are meticulously configured with optimal filter sizes, strides, and padding to capture meaningful spatiotemporal patterns within video sequences. The plurality of convolutional modules are trained to recognize both spatial characteristics within individual frames and temporal dynamics across frames. The plurality of convolutional modules operate both in sequential (four convolutional blocks) and in parallel mode (INC block).

The plurality of convolutional modules in sequential mode comprises of a first convolutional layer (103), a second convolutional layer (105), a third convolutional layer (107), a fourth convolutional layer (109).

The INC Block (operates in parallel mode) consists of the following:
a) The INC convolutional module consists of three Conv3D blocks operating at scales of 3×3, 5×5, and 7×7 to capture features at various granularities.
b) Applies MaxPool3D after each Conv3D block to reduce spatial dimensions and extract prominent features.
c) Utilizes Batch Normalization to stabilize activations within each mini-batch for faster convergence and improved generalization.
d) Concatenates the outputs of all Conv3D branches along the channel dimension to create a richer representation of the input volume.

The structure of the four convolutional layer (operate in sequential mode) is as follows:

### First Convolutional Layer:

a) 3D Convolutional Layer: Applying a 3D convolution with 32 filters, a kernel size of (3, 3, 3), ReLU activation with ‘same’ padding.
b) Batch Normalization: Normalizing the output of the convolutional layer.
c) 3D Max Pooling: Applying 3D max pooling with a pool size of (2, 2, 2) and strides of (2, 2, 2).

### Second Convolutional Layer:

Repeating the same structure as the first convolutional layer (103) with 64 filters.

Third Convolutional Layer with Skip Connection:
a) Applying a 3D convolution with 128 filters, a kernel size of (3, 3, 3), ReLU activation, and ‘same’ padding.
b) Batch Normalization.
c) Applying 3D Convolution with 128 filters and a 1×1×1 kernel (for skip connection).
d) Applying 3D Convolution with 128 filters and a 3×3×3 kernel.
e) Batch Normalizing the output of the convolutional layer.
f) Applying 3D Max Pooling with pool size of (2, 2, 2) and strides of (2, 2, 2).
g) Adding the output of the Batch Normalization layer (step b) and the output of the 1×1 convolution layer (step c).

### Fourth Convolutional Layer:

a) Applying 3D Convolution with 256 filters and a 1×1×1 kernel.
b) Applying a 3D convolution with 256 filters and a 3×3×3 kernel.
c) Batch normalization.
d) Adding the output of the Batch Normalization layer (step c and the output of the 1×1 convolution layer (step a).

### Bi-LSTM (Long Short Term Memory) Module:

a) Time-Distributed Flatten Layer to prepare the data for long short term memory (Bi-LSTM) module (120).
b) Bidirectional LSTM module (120) with 512 units and return sequences.

### Additional Layers:

a) Dense Layer with tanh activation.
b) Softmax Activation Layer.

### Multiply Layer:

a) Element-wise multiplication (113) between the Bi-LSTM (long short term memory) output and the output from the Softmax layers.
b) Summation (Reduction) (115): Sum along the time dimension (axis 1) of the output from the Multiply Layer (113).

### Output Layer:

a) Dense Layer with a Softmax activation function: The number of units in the output layer is determined by the number of activities (or, categories/classes) in the video dataset. The dense layer with softmax activation, contributes to the final classification. The layers integrate both spatial and temporal information to make predictions regarding the human's activity in the video sequence. Thus the system (101) integrates spatial and temporal information through a combination of 3D convolutional layers, 3D max pooling layers, Bi-LSTM module (120), skip connections, multiply and element-wise summation. The elements work together to effectively capture spatial patterns in individual frames and temporal dynamics across the video sequence, providing a comprehensive representation for human activity recognition.

### Stage 4—Bidirectional LSTM (Bi-LSTM) Layers for Sequential Modeling

Bidirectional Long Short-Term Memory (Bi-LSTM) module has been incorporated to employ temporal dependency effectively for capturing bidirectional temporal relationships within video sequences. By processing the sequences both forward and backward directions, the system (101) achieves a deeper understanding of how activities unfold over time.

A Bidirectional Long Short-Term Memory (BI-LSTM) module (120) is a type of recurrent neural network (RNN) layer that processes input sequences in both forward and backward directions. Bidirectional long short-term processing allows the system (101) to capture dependencies in both past and future context, making the processing particularly effective for tasks involving sequential data, such as natural language processing and time-series analysis. Here's a detailed explanation of the functional aspects and steps involved in processing with a BI-LSTM module (120):

### Sequential Input:

The BI-LSTM module (120) takes a sequential input, where each element in the sequence represents information at a specific time step. In the context of human activity recognition system (101), the sequential input could be a sequence of feature vectors extracted from video frames over time.

### Forward and Backward Processing:

The BI-LSTM module (120) processes the input sequence in two directions: forward and backward. The forward pass processes the sequence from the beginning to the end, while the backward pass processes in reverse.

### Hidden States and Cell States:

At each time step, the BI-LSTM maintains hidden states and cell states. The states capture information about the input sequence and the context. The hidden states act as memory, store information relevant to the processing of the sequence.

### Gating Mechanisms:

The BI-LSTM uses gating mechanisms, including input gates, forget gates, and output gates, to control the flow of information through the network. The gates determine which information is retained in the hidden states and cell states and which information is discarded.

### Forward and Backward Outputs:

The BI-LSTM produces two sets of outputs: forward and backward outputs. The forward output represents the hidden states when processing the sequence in the forward direction, and the backward output represents the hidden states when processing in the backward direction.

### Concatenation:

The forward and backward outputs are concatenated along the feature dimension. The concatenation results are in a representation that incorporates information from both the past and future context for each time step in the input sequence.

### Final Output:

The concatenated outputs serve as the final output of the BI-LSTM module. The output is then typically passed to subsequent layers in the neural network for further processing, such as additional dense layers or classification layers.

### Parameter Learning:

During training, the parameters of the BI-LSTM module, including weights and biases, are learned through backpropagation and optimization algorithms such as stochastic gradient descent. The system (101) adjusts the parameters to minimize the difference between predicted and actual outputs.

The BI-LSTM module (120) excels at capturing long-range dependencies in sequential data, making the module suitable for tasks where context from both past and future is important. In the context of human activity recognition system (101), the Bi-LSTM module (120) helps in understanding the temporal dynamics of the video sequences, enabling the system (101) to make predictions based on the combined information from different time steps.

Skip Connections: The inclusion of skip connections between plurality of convolutional modules contribute to more effective gradient flow during training and improved system (101) performance to create shortcuts for information to flow between layers by bypassing certain layers, aiding in the capture of both fine-grained and high-level features and further accelerates the system's (101) convergence and improves its adaptability to different datasets.

The effectiveness of skip connections in improving gradient flow during training and enhancing system's (101) performance has been demonstrated in various deep learning architectures. Skip connections, particularly in the form of residual connections, have shown positive impacts on training convergence, generalization, and system's (101) adaptability.

Here are a few key points supported by empirical evidence:

Improved Gradient Flow: Skip connections facilitate the flow of gradients during backpropagation by providing shortcut paths for information to pass through the network. Skip connections helps to mitigate the vanishing gradient problem and enables more effective learning of both low-level and high-level features.

Training Convergence: Residual connections have been shown to accelerate the convergence of training. The ability of skip connections to carry (propagate) gradients directly to earlier layers helps in training deeper networks without facing issues like vanishing or exploding gradients, which occurs in very deep architectures.

System's Performance: The inclusion of skip connections often improve system's (101) performance of 2.3% in our case (average across 20 simulations), especially, in terms of accuracy and generalization. The inclusion of skip connections has been observed in various computer vision tasks, including image classification, object detection, and semantic segmentation.

Robust Recognition of Diverse Activities: The present invention recognizes a wide range of human activities, including subtle and complex actions. The system ability is to capture both spatial and temporal cues enable the system to excel in real-world scenarios with diverse activities and backgrounds.

### Benchmarking on UCF101 Dataset:

Extensive experiments and evaluations have been conducted using the UCF101 dataset, which serves as a benchmark for testing and validating the preferred embodiment. The system's (101) performance has been rigorously assessed and compared with existing methods, consistently demonstrating superior accuracy.

In another embodiment, the present invention provides a deep learning based human activity recognition method, comprising the steps of:
(a) gathering a video dataset from a predefined dataset containing human activities;
(b) resizing the video dataset to ensure a consistent resolution across a plurality of frames of the video dataset for facilitating uniform processing;
(c) extracting a plurality of spatial features from the plurality of frames of the video dataset to identify activity recognition;
(d) employing a plurality of temporal features within the plurality of frames of the video dataset to understand the sequential evolution of human activities over time;
(e) enhancing gradient information flow and stabilizing training of the system by employing skip connections; and
(f) capturing the plurality of spatial features and the plurality of temporal features within the video dataset to dynamically allocating attention to relevant time steps and efficient training method.

FIG. 1 illustrates the deep learning based human activity recognition system (101) in accordance with the disclosure. The data processing unit collects raw video data from a plurality of datasets containing various human activities that ensure uniformity in processing and resizing the videos to a consistent solution. The resizing step is vital for standardizing the input across a plurality of frames of the video to enable efficient feature extraction and facilitate effective human activity recognition.

A plurality of convolutional modules employ different filters to detect patterns and spatial features within the plurality of frames such as edges, textures, and object shapes. The spatial features are extracted from the plurality of frames pass through successive convolutional layers, extracting increasingly abstract features that aid in activity recognition.

The skip connections are introduced between the plurality of convolutional modules to improve gradient (information) flow and training stability. The skip connections enable the model to bypass certain layers, facilitating the flow of gradients during error back-propagation and alleviating the vanishing gradient problem. The incorporation of the skip connections within the plurality of convolutional modules, enhances the capacity of the system to capture intricate spatial features.

### Examples

The present invention is clearly understood from the following exemplary embodiments. The examples hereinbelow are the mere embodiments and should not be construed to limit the scope of the present invention.

### Example 1: The System Architecture

### Input Layer:

Shape: (SEQUENCE_LENGTH, IMAGE_HEIGHT, IMAGE_WIDTH, 3)

### First Convolutional Layer:

3D Convolution Layer:
Filters: 32 to 512 (we have fixed it to 32)
Kernel Size: (3, 3, 3) to (5,5,5)
Activation: ReLU
Padding: ‘same’
Batch Normalization Layer
3D Max Pooling Layer:
Pool Size: (2, 2, 2) to (3, 3, 3)
Strides: (2, 2, 2) to (3, 3, 3)
Second Convolutional Layer:
3D Convolution Layer:
Filters: 64 to 512 (we have fixed it to 64)
Kernel Size: (3, 3, 3) to (5,5,5)
Activation: ReLU
Padding: ‘same’
Batch Normalization Layer
3D Max Pooling Layer:
Pool Size: (2, 2, 2) to (3, 3, 3)
Strides: (2, 2, 2) to (3, 3, 3)
   Third Convolutional Layer with Skip Connection:
3D Convolution Layer:
Filters: 128 to 512 (we have fixed it to 128)
Kernel Size: (3, 3, 3) to (5,5,5)
Activation: ReLU
Padding: ‘same’
Batch Normalization Layer
3D Convolution Layer with 1×1×1 kernel (for Skip connection)
Filters: 128 to 512 (we have fixed it to 128)
Kernel Size: (1, 1, 1)
Activation: RELU
Padding: ‘same’
3D Convolution Layer:
Filters: 128 to 512 (we have fixed it to 128)
Kernel Size: (3, 3, 3) to (5,5,5)
Activation: ReLU
Padding: ‘same’
Batch Normalization Layer
3D Max Pooling Layer:
Pool Size: (2, 2, 2) to (3, 3, 3)
Strides: (2, 2, 2) to (3, 3, 3)
Element-wise Sum between the output of the first Batch Normalization in module 3 and the output of the 1×1×1 Convolution Layer.

### Fourth Convolutional Layer:

3D Convolution Layer with 1×1×1 kernel (for Skip connection):
Filters: 8 to 512 (we have fixed it to 256)
Kernel Size: (1, 1, 1)
Activation: RELU
Padding: ‘same’
3D Convolution Layer:
Filters: 8 to 512 (we have fixed it to 256)
Kernel Size: (3, 3, 3) to (5,5,5)
Activation: ReLU
Padding: ‘same’
Batch Normalization Layer

Element-wise Sum between the output of the previous Batch Normalization Layer and the output of the 1×1×1 Convolution Layer.

### LSTM Layers:

### Time-Distributed Flatten Layer:

A “Time-Distributed Flatten Layer” in a neural network architecture applies the flatten operation across the temporal dimension of the input tensor, allowing for the transformation of each time step's feature maps into a one-dimensional vector while preserving the temporal structure.

### Bi-Directional LSTM:

Bidirectional LSTM Layer with 512 units and return sequences.

### Additional Layers:

Dense Layer with 1 neuron and activation ‘tanh’: A “Dense Layer with activation ‘tanh’” applies a fully connected layer with a hyperbolic tangent activation function, which squashes the output values to the range [−1, 1], providing non-linear transformations to the input data.

Softmax Activation Layer: A “Softmax Activation Layer” applies the softmax function to the input tensor, which converts the raw scores or logits into probabilities, ensuring that the output values sum up to 1. It's commonly used in multi-class classification problems to obtain attention scores. Here, the values represent the attention scores.

### Multiply Layer:

Element-wise multiplication between the Bi-LSTM output and the output from the additional layers.

### Summation/Reduction Layer:

Sum along the time dimension (axis 1) of the output from the Multiply Layer.

### Dense Layer:

Output layer with a Softmax activation function.

Number of units is determined by the number of activities present in the video dataset.

### Example 2

As shown in FIG. 1: a flowchart and architecture of the deep-learning based human activity recognition system and method thereof.

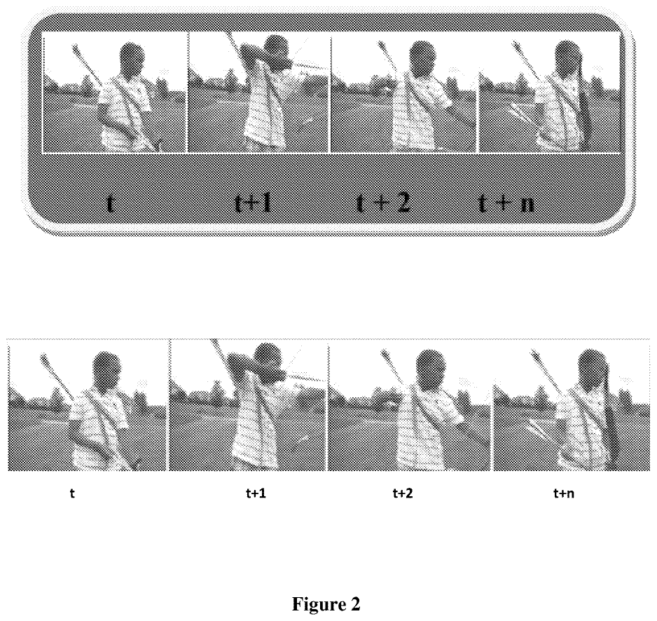

As shown in FIG. 2: a visual representation of selected frames or still images extracted from a single video sample in the context of the Archery action category to provide an overview of Archery action within the UCF 101 dataset or a similar dataset.

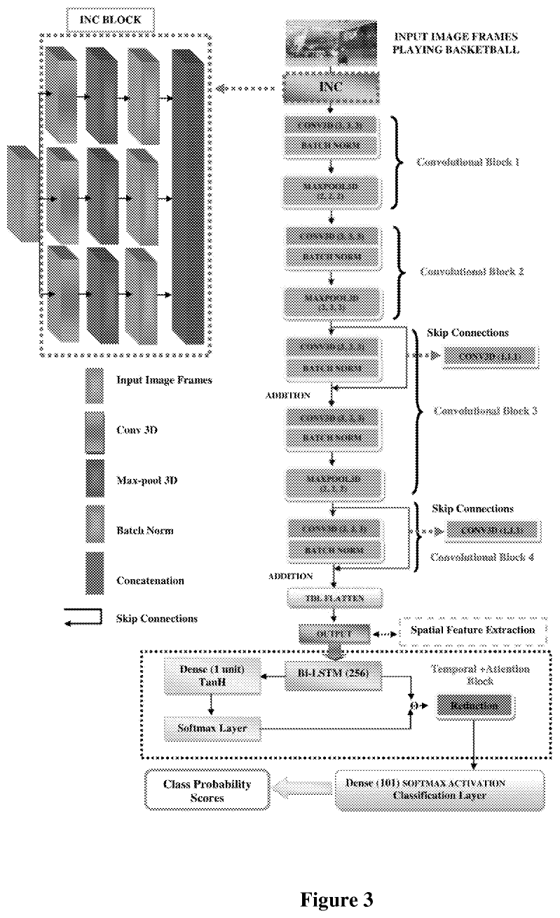

As shown in FIG. 3: The end to end structure of the Deep Neural Network to provide a visual representation of all specific modules or components.

### Example 3: Changes in Dimension after Each Module

Input Layer:
Input Shape: (16, 112, 112, 3)
INC BLOCK:

The output shape after each Conv3D block (before max-pooling) will be (16, 112, 112, 8).

After MaxPool3D, the output shape for each branch will be (16, 56, 56, 8).

Batch normalization does not affect the shape.

After concatenation, the resulting tensor shape will be (16, 56, 56, 24), as there are 3 branches each with 3 channels.

### First Convolutional Layer:

Conv3D: (16, 56, 56, 32)
BatchNormalization: (16, 56, 56, 32)
MaxPooling3D: (8, 28, 28, 32)

### Second Convolutional Layer:

Conv3D: (8, 28, 28, 64)
BatchNormalization: (8, 28, 28, 64)
MaxPooling3D: (4, 14, 14, 64)
   Third Convolutional Layer with Skip Connection:
Conv3D: (4, 14, 14, 128)
BatchNormalization: (4, 14, 14, 128)
Conv3D (1×1): (4, 14, 14, 128)
Skip Connection (Add): (4, 14, 14, 128)
Conv3D: (4, 14, 14, 128)
BatchNormalization: (4, 14, 14, 128)
MaxPooling3D: (2, 7, 7, 128)

### Fourth Convolutional Layer:

Conv3D: (2, 7, 7, 256)
BatchNormalization: (2, 7, 7, 256)
Conv3D (1×1): (2, 7, 7, 256)
Skip Connection (Add): (2, 7, 7, 256)

### Bi-LSTM Layers:

Time-Distributed Flatten: (2, 12544)
Bidirectional LSTM: (1, 512)

### Additional Layers:

Dense Layer: (1, 512)
Softmax Activation Layer: (512)

### Multiply Layer:

Element-wise multiplication: (1, 512)

### Summation (Reduction) Layer:

Sum along the time dimension: (512)

### Output Layer:

Dense Layer with Softmax activation: (Number of classes)

### Example 4: Classification Performance of the Method as to the State-of-the-Art Models for the UCF 101 Dataset

TABLE 1

| | | UCF101 |
|---|---|---|
| METHOD | PARAMETERS | (Accuracy) |
| ResNet-18 | 33.2M | 84% |
| ResNet-50 | 46.4M | 86% |
| ResNet-101 | 85.5M | 86.6% |
| Ours (1 net) | 5.5M | 87.88% |
| Ours (3 net) | — | 92% |

The Table (Table 1) illustrates a comparison table that provides information about different methods or models, along with their corresponding parameters (number of parameters), and their performance accuracy on the UCF101 dataset. The table compares several models, including ResNet-18, ResNet-50, ResNet-101, and two versions labeled as “Ours” with different configurations.

### Description of the Table:

Method: The column lists the various methods or models being compared. The methods/models include ResNet-18, ResNet-50, ResNet-101, and two versions referred to as “Ours” (representing the method in the present invention).

Parameters: The column shows the number of parameters required in each model. The number of parameters is an essential factor in determining the model's complexity and memory requirements. The number of parameters represent the total learnable weights and biases in the neural network.

UCF101 (Accuracy): The column displays the accuracy achieved by each method/model on the UCF101 dataset. Accuracy is a common evaluation metric used in classification tasks, indicating the proportion of correctly classified instances.

In a prior art, (ResNet-18): The model comprises of 18 layers, has 33.2 million parameters and achieves an accuracy of 84% on the UCF101 dataset. The model is known for simplicity, and effectiveness in image classification tasks, particularly in the domain of computer vision.

In another prior art, (ResNet-50): The model comprises of 50 layers and is more complex with 46.4 million parameters and achieves a slightly higher accuracy of 86% on the UCF101 dataset. However, the model is developed to address the vanishing gradient problem by utilizing skip connections or residual blocks to allow for deeper networks while maintaining performance.

In yet another prior art, (ResNet-101): The model comprises of 101 layers, employs even more complexity, with 85.5 million parameters, and achieves an accuracy of 86.6% on the UCF101 dataset. However, the model is developed to address the vanishing gradient problem by utilizing skip connections or residual blocks to allow for deeper networks while maintaining performance.

In the first architecture, Ours (1 net) was utilized: The first version of the present invention refers to the single model, has 5.5 million parameters and achieves a higher accuracy of 87.88% on the UCF101 dataset. The 1-net refers to the single model

In the second architecture, Ours (3 net) was utilized: The second version of the present method, labeled as “Ours (3 net)” refers to three models, has more parameters than “Ours (1 net)” but still significantly less than the ResNet models, with no specific parameter count listed (please note that the number of parameters of the first architecture is multiplied with a factor of the number of nets used in the second architecture) and achieves the highest accuracy, reaching 92% on the UCF101 dataset.

The homogeneous ensemble refers to the collective use of multiple neural network architectures within the same framework for human activity recognition. Each 1-net architecture in homogeneous ensemble specializes in either spatial and/or temporal processing, and the ensemble achieves a more comprehensive analysis of video data. The method differs from prior art technologies by leveraging the strengths of different architectures to address the challenges of capturing spatiotemporal patterns effectively.

### Example 5: Performance Metrics for the System

TABLE 2

| | | UCF101 |
|---|---|---|
| | UCF101 | Accuracy@ |
| Method | Accuracy@ 1 | 5 |

C3D
Architecture

| | | |
|---|---|---|
| 3D ST | 60.6 | — |
| MAS | 61.2 | — |
| RSPNet | 76.7 | — |
| Ours(1 net) | 87.88 | 93.56 |
| Ours(3 net) | 92 | 97.74 |

Table 2 gives the comparison table that provides information about different methods or models and their performance metrics on the UCF101 dataset. The table includes various methods or models, such as the C3D architecture: 3D ST, MAS, RSPNet, and two versions labeled as “Ours” with different configurations. The performance metrics included are “UCF101 Accuracy@1” and “UCF101 Accuracy@5,” which represent the top-1 and top-5 accuracy, respectively, on the UCF101 dataset.

### The Metrics Comprise of:

Method: The column lists the different methods or models being compared, including their names or abbreviations.

UCF101 Accuracy@1: UCF101 Accuracy@1 represents the top-1 accuracy achieved by each method on the UCF101 dataset. Top-1 accuracy measures the proportion of correctly classified instances when considering only the top-most predicted class.

UCF101 Accuracy@5: UCF101 Accuracy@5 represents the top-5 accuracy achieved by each method on the UCF101 dataset. Top-5 accuracy considers the proportion of correctly classified instances when considering the top five predicted classes, which is a measure of how well the system (101) performs when the correct class is not the most confidently predicted.

### Advantages of the Invention

Using Deep Spatiotemporal Neural Network for enhanced Human Activity Recognition, offers several advantages:
Enhanced Accuracy: the method using Deep Spatiotemporal Neural Network improves the accuracy of human activity recognition in recognizing complex human activities from video data. By integrating spatial and temporal information and dynamically allocating, and outperforms existing methods, reducing recognition errors. The system (101) provides 92% accuracy on the UCF101 dataset having 16.5 million parameters exhibiting lesser complexity in comparison to prior arts as shown in Table 1.
Robustness:
The system effectively handle variations in activity duration, speeds, and environmental conditions, making the system more reliable for real-world applications.
Real-World Applicability:
The system's (101) versatility and high accuracy make the system suitable for real-world applications in diverse domains.
Improved Human-Computer Interaction:
The present invention enhances user experience in human-computer interaction scenarios, which enables in developing more intuitive and context-aware systems (101).
The invention represents advancement in the field of human activity recognition by introducing a deep spatiotemporal architecture with Conv3D layers and Bi-LSTM.
Its ability to recognize diverse human activities in video data holds great promise for practical applications and represents a significant leap forward in the domain of computer vision and deep learning.
User-Friendly Implementation:
The methodology has been designed with user-friendliness in mind, offering straightforward integration into existing systems and workflows. The methodology has been deployed on various hardware platforms, making the methodology adaptable to different computing environments.
Adapatabilty:
The methodology architecture has been designed to be adaptable, allowing for future improvements and updates. The methodology is fine-tuned for specific applications and datasets, ensuring versatility and adaptability.

### Example 6: Process for Human Activity Recognition

The process involves utilizing convolutional neural networks to extract spatial features from individual frames of video data.

Convolutional Neural Networks: Convolutional Neural Networks (CNNs) are widely used in computer vision tasks to effectively extract features from images. A convolutional module typically consists of convolutional layers followed by pooling layers, which are responsible for capturing spatial patterns at different scales.

Set of Individual Frames: The videos are essentially a sequence of individual frames or images played in rapid succession. The sequence of individual frames capture a snapshot of the scene at a particular moment in time. By treating each frame as an individual image, the convolutional neural networks are employed to extract spatial features.

Extracting Spatial Features: Spatial features refer to the visual patterns and structures present within each frame. Spatial features include objects, textures, shapes, edges, or any other visual cues that are relevant to the task at hand. The convolutional neural network analyzes each frame and identify the features through a process known as feature extraction.

Detecting Patterns and Spatial Information: Once the spatial features are extracted from each frame, the system analyzes the plurality of frames to detect patterns and spatial information. The spatial features involve identifying specific objects, recognizing actions or activities, tracking motion, or any other task and understands the spatial arrangement of elements within the frame.

Illustration: Imagine a video stream of a traffic intersection. The plurality of frames of the video represents a snapshot of the intersection at a particular moment in time. The convolutional modules analyze each frame individually, identifying spatial features such as cars, pedestrians, traffic lights, and road markings. The spatial features are then used to detect patterns, such as the movement of vehicles or the behavior of pedestrians, and extract spatial information, such as the positions of objects within the scene. The process allows the system to understand and interpret the visual content of the video in real-time, enabling applications such as traffic monitoring, autonomous driving, or surveillance.

Although the embodiments herein are described with various specific embodiments, it will be obvious for a person skilled in the art to practice the invention with modifications. However, all such modifications are deemed to be within the scope of the invention.

We claim:

1. A deep learning based human activity recognition system (101), comprising:
a data processing unit;
a plurality of convolutional modules comprises an INC convolutional module, a first convolutional layer (103), a second convolutional layer (105), a third convolutional layer (107) and a fourth convolutional layer (109);
a skip connection installed in the fourth convolutional layer;
a long-short term memory (LSTM) module (120) connected with the fourth convolutional layer;
an arithmetic module connected with the LSTM module (120);
an output unit connected with the arithmetic module;
wherein,
(i) the data processing unit gathers a plurality of frames of a video dataset containing human activities and resizes the video dataset for facilitating uniform processing;
(ii) the plurality of convolutional modules extract a plurality of spatial features from the plurality of frames of the video dataset;
(iii) the LSTM module (120) captures a plurality of temporal features within the plurality of frames of the video dataset to understand the sequential evolution of human activities over time; and
(iv) the skip connection bypass a plurality of convolutional layers to improve gradient flow information and training stability.

2. The deep learning based human activity recognition system (101), comprising:
a graphics processing unit;
a central processing unit to process data and manage a training process of the system;
a memory unit to store and access large datasets during the training process of the system;
a storage module;
an internet connectivity to provide stable internet connection;
a server for deploying the graphics processing unit, the central processing unit, the memory and the storage;
a network is facilitated for communication between the deployed units and a plurality of platforms.

3. The deep learning based human activity recognition system (101) as claimed in claim 1, wherein the plurality of convolutional modules configured to perform 3D convolution, batch normalization and 3D max pooling.

4. The deep learning based human activity recognition system (101) as claimed in claim 2, wherein the graphical processing unit facilitates deep learning tasks for accelerating the training of the system (101).

5. The deep learning based human activity recognition system (101) as claimed in claim 1, wherein the graphical processing unit is preferably a V100 GPU.

6. The deep learning based human activity recognition system (101) as claimed in claim 1, wherein the arithmetic modules include multiply layer (113) and summation layer (115).

7. The deep learning based human activity recognition system (101) as claimed in claim 1, wherein the plurality of platforms include but not limited to, Google Colab.

8. The deep learning based human activity recognition system (101) as claimed in claim 1, wherein the LSTM module (120) is preferably a bidirectional long short term memory.

9. A deep learning based human activity recognition method, comprising the following steps:
i. collecting video data from a plurality of datasets to capture human activity;
ii. resizing the video data to a consistent resolution;
iii. extracting spatial features using a plurality of convolutional modules to extract spatial features from a set of individual frames of the video data to detect patterns and spatial information within each frame;
iv. employing temporal dependencies within video sequence to understand sequential evolution of human activities through a bidirectional long short term memory layer;
v. reducing the dimensions of the video sequence and producing an additional output to represent attention scores through an additional layer;
vi. multiplying element wise between the output produced from LSTM layer and the additional output via a multiply layer and obtaining an enhanced output;
vii. summing up the original input and an enhanced output for yielding a final output shape; and
viii. enabling the system (101) to capture intricate patterns in spatiotemporal data for accurate classification.

10. The method as claimed in claim 9, wherein the bidirectional long short term memory layer is in the range of 64 to 512 units.

11. The method as claimed in claim 9, wherein the additional output received in step (v) is of 64 to 512 units.

12. The method as claimed in claim 9, wherein the output obtained in multiply layer in step (vi) is in the range of 64 to 512 units.

13. The method as claimed in claim 9, wherein the output obtained in summation layer in step (vii) is in the range of 64 to 512 units.
